(19) United States
(12) Patent Application Publication
(10) Pub. No.: US 2006/0243805 A1
(43) Pub. Date: Nov. 2, 2006

(54) Device of eye-gaze tracking, for control, static and semi-static images

(76) Inventor: Igor Gregor Mative, Nahariya (IL)

Correspondence Address: Mr.Igor Gregor Mative, Silver 12/7, Nahariya, IL

(21) Appl. No.: 10/908,070

(22) Filed: Apr. 27, 2005

(51) Int. Cl. G06K 7/10

(52) U.S. Cl. 235/462.01

(57) ABSTRACT

The present invention relates to eye-gaze tracking system. There are two main differences, between the given innovation and other ideas in this area. The first is a distance from user's eyes up to the screen always a permanent. There is no necessity to create the additional detector for distance definition, from eyes up to the display. Finally, that the given invention can uses static image, images which are not change. Also the present invention uses very simple algorithm of signal processing. That is a unique technology named by author “Static Image Detection Procedure” (S.I.D.P).

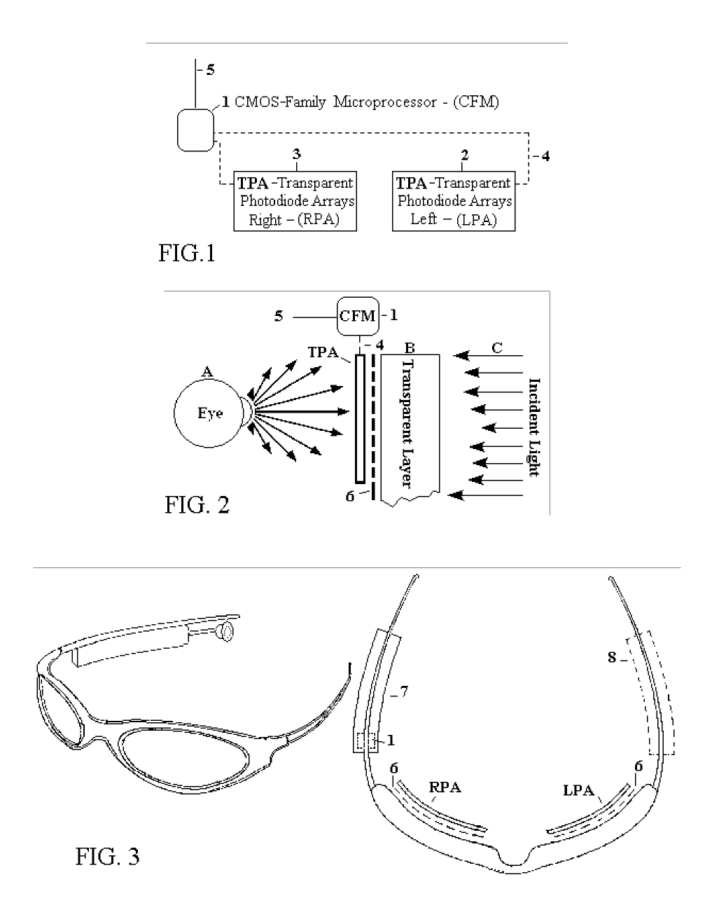

The FIG. 1 illustrates major participants and their interrelations. Transparent photodiodes arrays 2 and 3 are connected by wires 4 to the microprocessor-1. The processor <<CMOC>> takes as a basis where is possible to use of lesser complex processor, agreeable to the standards (serial signals processing of two photodiodes). The microprocessor is connected to the O.S 5 and sends information about eye-gaze direction of a user. The voltage received by the processor depends on its type and is not a severe requirement.

In a following FIG. 2, four more participants are added. The given picture represents full system of the present invention. Falling light C passes through a transparent plate B on which fastened a thin transparent film of static images-6. The following layer standing after a film(6), photodiode arrays—TPA. Light passes through it without distortions. Reaches an eye A and begin to reflect from it, where the some part of reflected light falls to the photodiode. Falling light on the diode from the internal side creates a process named as “Internal Photoemission”. Each of cells of the photodiode receives the certain quantity of photons reflected from an eye. The process “electron-hole”, will transform electromagnetic radiation, received by a cell of the photodiode to a photocurrent. The photocurrent or electricity is defined by a voltage which is proportional to quantity of photons got in a cell of the diode. Thus the processor 1, on connection 4, receives the information on a voltage of a photocurrent, will transform it to the logic conclusion and sends result on the channel 5, to operational system. In more detail this process of transformation will be discussed later.

Companies Motorola and Oakley (http://oakley.motorola.com/flash.html-http://oakley.com), have released a new product—sunglasses with built in MP3 player. To adapt LCD screen to this model of sunglasses, at the present time is not so easy. Modem technology has the certain limits. Hence to use eye-gaze tracking detection system today is impossible. The present invention has special solution for this problem. The given approach not gives 100 percent solution, nevertheless creates possibility to use it. On FIG. 3 demonstrates design of sunglasses. Photodiodes (LPA and RPA) with a thin film of symbols (static images) attached to the glass from internal side of sunglasses. Thus the photodiode situate on all perimeter of glass. Microprocessor 1, will be placed there where situate MP3 hardware. In last versions of these sunglasses, hardware of MP3 player, were placed on two sides 7 and 8. Thickness of photodiodes arrays and film of static images, will not exceed 2 mm, hence will not cause inconvenience for users.

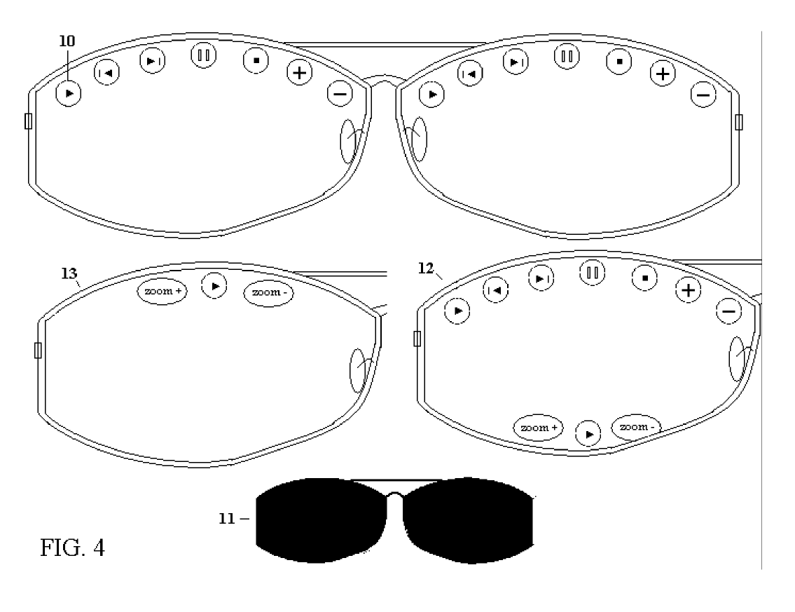

The FIG. 4 represents design of symbols for MP3 player 10 and similar devices 13, 12. From the external side of glasses, symbols will be not visible (11), as reflected light from eyes, which carries information about these symbols, in a greater degree will be transformed in photocurrent or in voltage. The film of static images may be made from any transparent material, which has a thickness approximately 0.5 mm.

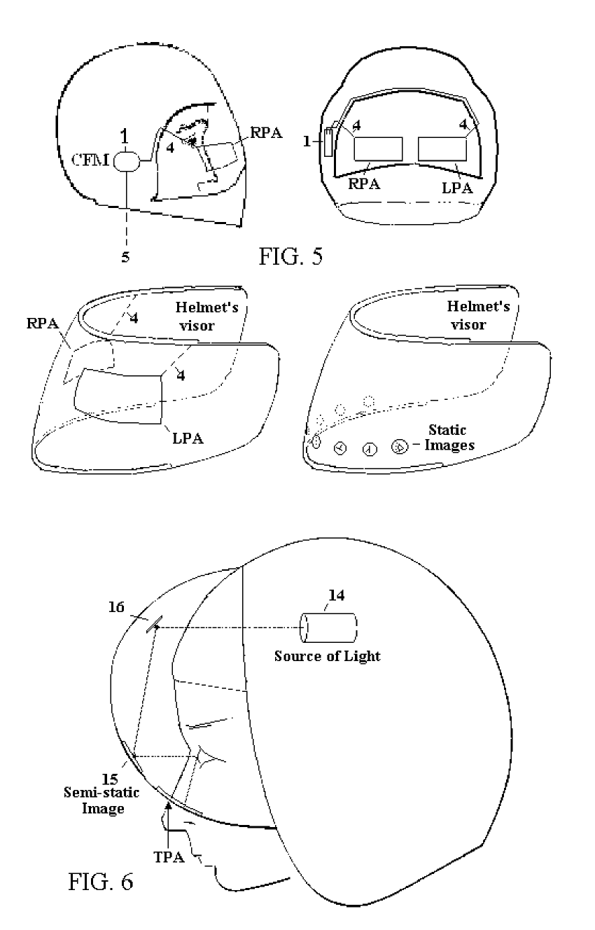

As shown in FIG. 5, the invention without problems can be integrated in a helmet of the motorcyclist. The processor 1, can be placed on one of the sides of helmet to and connect through wires 4, with photodiodes (left LPA and right RPA). In this case static images will be placed on helmet's visor below the photodiodes which in turn situated at eyes level of the motorcyclist.

The FIG. 6 shows new one kind of symbols, semi-static images. They will be applied on an example in helmet of aircraft pilot. The main difference between semi-static and static symbols, that the semi-static has not a physical foundation and time of their life is define by a source of light. Unites their, that they always have one form and the same distances between itself, the place of their display is always identical. All system work occurs under the standard scenario. The light source is reflected from a mirror 16 and creates the image in idea of symbols on a helmet's visor 15. Falling light 16 and light of source reflected from a visor, also reflected from eye, and falls to the photodiode TPA. Semi-static symbols can update by special scenario. For example while the aircraft fly up, pilot see one type of icons (symbol), when come in the land, other type. The mechanism, “symbol recognition” shows in FIGS. 7, 8 and 9. The first step of process is signal optimization that receives from photodiodes. This process is based on transformation of signals where there are only two values 0 or 1. The human eye consists of a white part from which reflection of light is more intensively and dark part or pupil (blue, green, brown or black) where intensity of reflection much more weakening. This principle of a light reflection is taken for a basis of process of optimization. The FIG. 7 shows total of signals in form of matrix 10×10.

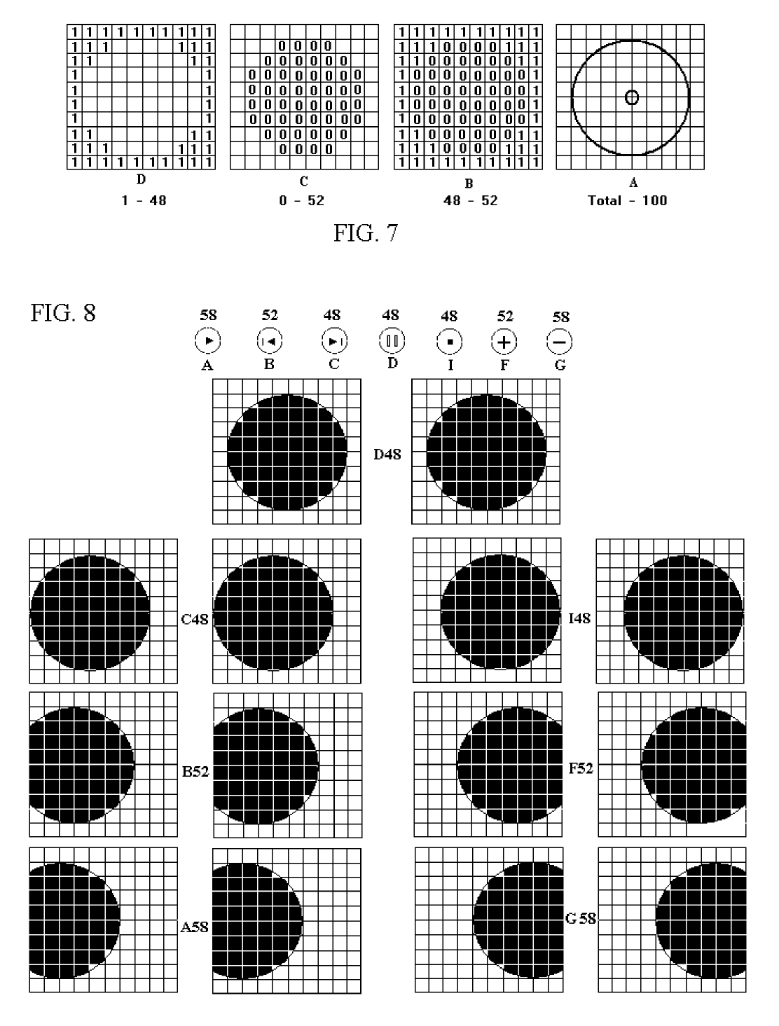

“A” is arbitrarily chosen scale of an eye. All signals received from the photodiode's cells have different values. Process of optimization levels the maximal values to unit, and the least to zero. Thus we receive a picture “B” where the matrix consists from 0 and 1. Further are shown separately a matrix of units “D” and zero “C” where shown sums of values. As shown on “D”, sum of values equal 48. FIG. 8 shows, how direction of eye-gaze, depends on sum of matrix's values. Above in picture are shown symbols. The symbol “stop” D is on the middle, hence when user will look at this symbol, the pupil of an eye, also will be is on the middle relatively an eye's apple. In this case the picture of an eye will correspond to D48.

The sum of matrix's values will be equal 48. The pupil is completely within the limits of a matrix. Now we shall force the user to look at next symbol, left or right relatively the middle—C48 and I48. The pupil though is displaced from the center, but it is within the matrix, the sum of values will be also equal 48. Here we received two new symbols, together with D48 already 3 symbols with the same sum of value (48). The next four symbols will be checked by the same method. In these cases the pupil will be displaced more from the middle to the left or to the right, hence quantity of units will increase. We receive B52, F52 and A58, G58.

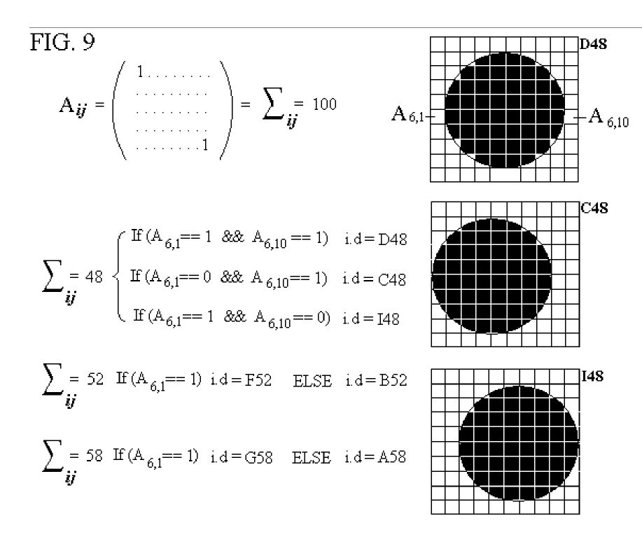

We pass to last part of “symbol recognition”. The FIG. 9 shows algorithm which makes identification of symbols by a value's sum. Matrix <<Aij>> (row i, column j) has quantity of cells, equal 100. The sum of values in case each cell is equal to unit, will be 100. Now will imagine that we started a process and after optimization the sum of a matrix equal 48. We know that the given “number” can correspond to three symbols, I48, D48 and C48. We take the received matrix and we check value of a field (cell) “A1,6” and “A1,10”. If both of them will be equal 1, in this case user looks at the symbol “stop” D48. If “A1,6” equal 0 and “A1,10” equal 1 thus, symbol C48 was chosen, otherwise 148. In case the sum of a matrix will be equal 52 or 58, it's necessary to check only one cell—“A1,6”. Thus the code of algorithm “symbol recognition” will very compact, hence more trustworthy.

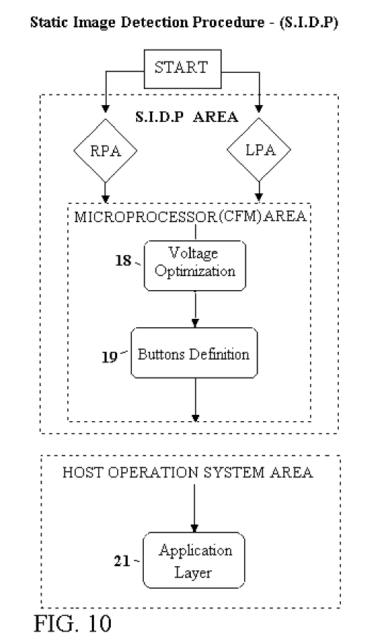

The given block-scheme (FIG. 10) describes behavior of system named as S.I.D.P. The system is intended for sunglasses embodiment with MP3 or similar devices, where transparent control buttons is puts on glass of sunglasses as permanent graphic images or semi-static images created by source of light. Process will start when the light is reflected from eyes of the user and falls on photodiodes plates (LPA and RPA). The information from each cell of the right and left photodiodes, enter to the microprocessor. Signals from the diode are optimizing (18) in 0 and 1, as was discussed above. Then optimized data, in form matrix passes to next module 19, where is start a process—“symbol recognition”. The process found a symbol, and transmits ID of symbol through the host operation system directly to an application 21

What is claimed is:

1. An eye-gaze tracking system for static and semi-static images—“Static Image Detection Procedure” (S.I.D.P). S.I.D.P-system, for devices where is distance from screen till eyes, has a permanent distance. The system (S.I.D.P) consists from two transparent photodiodes arrays, one microprocessor and transparent thin film with images. S.I.D.P-system, also can uses a semi-static images (without thin film of images), images that are created by source of light, and not have a physical basis.

2. S.I.D.P-system eye-gaze tracking for use in helmet of aircraft pilot or motorcyclist for system control.

3. S.I.D.P-system eye-gaze tracking of claim 2, wherein the helmet of aircraft pilot or motorcyclist, with adding transparent thin film of images in internal side of helmet's visor.

4. S.I.D.P-system eye-gaze tracking for use in sunglasses-MP3 for buttons switch.

5. S.I.D.P-system eye-gaze tracking for use in sunglasses embodiment with digital camera for zooming and makes a photo.

6. S.I.D.P-system eye-gaze tracking for use in sunglasses embodiment with radio type (FM-AM) for buttons switch.

7. S.I.D.P-system eye-gaze tracking for use in sunglasses-mobile phone for buttons switch.
